(19) United States
(12) Patent Application Publication
(10) Pub. No.: US 2006/0041464 A1
(43) Pub. Date: Feb. 23, 2006

(54) System and method for developing an analytic fraud model

(75) Inventors: Anthony Powers, Lombard, IL (US); Kimberly W. Reher, St. Charles, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: TransUnion LLC.

(21) Appl. No.: 10/921,712

(22) Filed: Aug. 19, 2004

(51) Int. Cl. G07G 1/00

(52) U.S. Cl. 705/10; 705/16

(57) ABSTRACT

A system and method is provided for developing an analytic fraud model to predict likelihood that a transaction is fraudulent comprising a first database storing a log of credit transaction information comprising requests for credit reports and including application information used by a credit requestor. A second database stores deleted credit inquiries. The deleted credit inquiries comprise fraudulent requests for credit reports. A programmed processing system is operatively associated with the first and second databases and operates in accordance with a sampling program. The sampling program filters the stored deleted credit inquiries for a select period to obtain a sample of fraudulent transactions, obtains select fraudulent credit transaction information from the log for the sample of fraudulent transactions, obtains a sample of random credit transaction information for the select period from the log, and processes the fraudulent credit transaction information and the random credit transaction information to determine characteristics of fraudulent and non-fraudulent application information used by credit requester. A predictive fraud model is developed using the determined characteristics.

### FIELD OF THE INVENTION

This invention relates to modeling to predict likelihood that a transaction is fraudulent and, more particularly, to determining the characteristics of fraudulent and non-fraudulent application information for developing a model.

### BACKGROUND OF THE INVENTION

Identity fraud costs companies billions of dollars every year. As identity theft becomes more sophisticated, losses continue to climb higher. Protecting businesses against fraud has become more important and more difficult.

Various method have been used to verify identity. At one time basic validation checks verified whether social security numbers were valid and not issued to deceased persons. Also, addresses and phone numbers involved in previous cases of fraud could be flagged as suspicious. Also, systems could match zip codes with telephone area codes, and many aspects of a person's identity could be verified using third party databases. More recently, systems have been developed that leverage customer data information technology to bring multiple aspects of a person's identity together from many sources. Issues such as change of address, marriage name changes and divorce could quickly be validated to reduce false positive rates.

This various information has been used to develop models that analyze information to determine if a request for credit or service is fraudulent. Typically models are developed using data provided by a customer or customers that will be using the model. In this scenario the data is often outdated and may not be indicative of the current trends in fraudulent activity. It is difficult to build a predictive model if the data is not predictive. It can also be difficult to obtain a large enough sample size for model development.

The present invention is directed to overcoming one or more of the problems discussed above in a novel and simple manner.

### SUMMARY OF THE INVENTION

In accordance with the invention, there is provided a system and method using current application information for known fraudulent individuals for developing an analytic fraud model.

Broadly, there is disclosed in accordance with one aspect of the invention the method of building a model to predict likelihood that a transaction is fraudulent, comprising storing a log of credit transaction information comprising requests for credit reports and including application information used by a credit requester; storing deleted credit inquires, said deleted credit inquiries comprising fraudulent requests for credit reports; filtering the stored deleted credit inquiries for a select period to obtain a sample of fraudulent transactions; obtaining select fraudulent credit transaction information from the log for the sample of fraudulent transactions; obtaining a sample of random credit transaction information for the select period from the log; processing the fraudulent credit transaction information and the random credit transaction information to determine characteristics of fraudulent and non-fraudulent application information used by credit requesters; and developing a predictive fraud model using the determined characteristics.

It is a feature of the invention that the application used by a credit requestor is selected from applicant's name, address, birth date, phone number and social security number or other indicative personal information.

It is another feature of the invention to verify that a credit request is fraudulent prior to deleting the fraudulent credit requests.

It is still a further feature of the invention that filtering the stored deleted credit inquiries comprises obtaining only most recent deleted credit inquiries.

It is still another feature of the invention that each request for credit is identified with a reference indicator and obtaining select fraudulent credit transaction information comprises cross-referencing the deleted credit inquiries with the log to obtain the reference indicators for the deleted credit inquiries and the reference indicators are used to obtain the application information used by fraudulent credit requester.

It is still another feature of the invention that obtaining a sample of random credit transaction information comprises obtaining application information for every Xth record in the log for the select period, wherein X is a positive integer.

It is yet another feature of the invention that filtering the stored deleted credit inquiries comprises obtaining all of the deleted credit inquiries for the select period.

It is still another feature of the invention that the select period comprises a select number of months.

There is disclosed in accordance with another aspect of the invention the method of developing an analytic fraud model, comprising storing a transaction log of application information used to make credit requests; deleting credit inquiries from credit files that are determined to be fraudulent; storing the deleted credit inquires; obtaining select fraudulent application information from the transaction log for the stored deleted credit inquiries for a select recent time period; obtaining a sample of random application information from the transaction log for the select recent time period; processing the fraudulent application information and the random application information to determine characteristics of fraudulent and non-fraudulent application information used to make credit requests; and developing a predictive fraud model using the determined characteristics.

There is disclosed in accordance with still another aspect of the invention a system for developing an analytic fraud model to predict likelihood that a transaction is fraudulent comprising a first database storing a log of credit transaction information comprising requests for credit reports and including application information used by a credit requestor. A second database stores deleted credit inquiries. The deleted credit inquiries comprise fraudulent requests for credit reports. A programmed processing system is operatively associated with the first and second databases and operates in accordance with a sampling program. The sampling program filters the stored deleted credit inquiries for a select period to obtain a sample of fraudulent transactions, obtains select fraudulent credit transaction information from the log for the sample of fraudulent transactions, obtains a sample of random credit transaction information for the select period from the log, and processes the fraudulent credit transaction information and the random credit transaction information to determine characteristics of fraudulent and non-fraudulent application information used by credit requester. Means are operatively associated with the programmed processing system for developing a predicted fraud model using the determined characteristics.

Further features of the invention will be readily apparent from the specification and from the drawings.

### BRIEF DESCRIPTION OF THE DRAWINGS

FIG. 1 is a block diagram of a fraud management platform in accordance with the invention;

FIG. 2 is a block diagram of a system for developing an analytic fraud model in conjunction with the fraud management platform of FIG. 1;

FIG. 3 is a flow diagram illustrating processing of fraudulent application information for developing a fraud model in accordance with the invention;

FIG. 4 is a flow diagram, similar to FIG. 3, for processing of non-fraudulent application information for developing a fraud model in accordance with the invention; and

FIG. 5 is a more detailed flow diagram illustrating the method of building a fraud model in accordance with the invention.

### DETAILED DESCRIPTION OF THE INVENTION

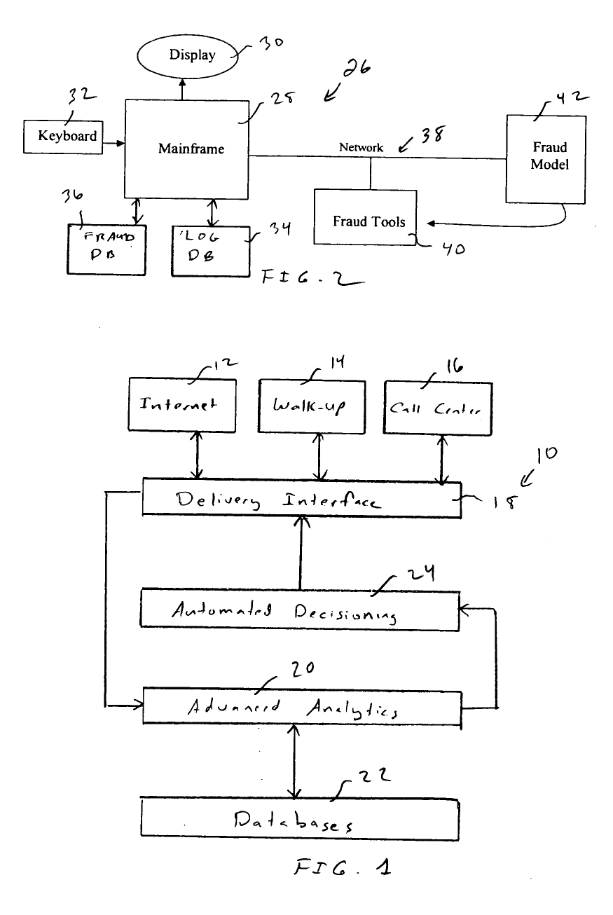

With reference to FIG. 1, a fraud management platform 10 uses a sample of fraudulent and non-fraudulent credit transactions from multiple industries. The sample is geographically dispersed. The development sample is constantly monitored to develop fraud models as fraud patterns change over time. The population consists of thousands of fraudulent transactions and hundreds of thousands of non-fraudulent transactions, using only confirmed fraudulent transactions in the development.

In an exemplary embodiment of the invention, the fraud management platform 10 can be accessed from various resources such as the internet 12, by walk-up sources 14, such as at a point of service, or via a call center 16, such as by telephone. These resources, 12, 14 and 16 operatively connect to a delivery interface 18 which receives applicant information from the resources 12, 14 and 16 and subsequently receives results and decisions via existing standard delivery interfaces for seamless integration. Particularly, the applicant information is provided from the delivery interface 18 to an advanced analytics block 20 which operates in conjunction with databases 22, storing a fraud model. The fraud model predicts the likelihood that an application is fraudulent and generates standardized reports to a customer to help tailor its fraud strategies. The advanced analytics block 20, as described below, may develop the fraud model. Alternatively, the model may be developed outside of the platform 10. The results from the fraud model are provided to an automated decisioning block 24 that applies customer business rules to the analytics report to generate instant, accurate decisions to the delivery interface block 18. If an identity can be verified, then the platform 10 drives an automated, interactive session for accurate and easy real-time identity authentication. As is apparent, the fraud model could be implemented in the decisioning block 24 or at a customer site.

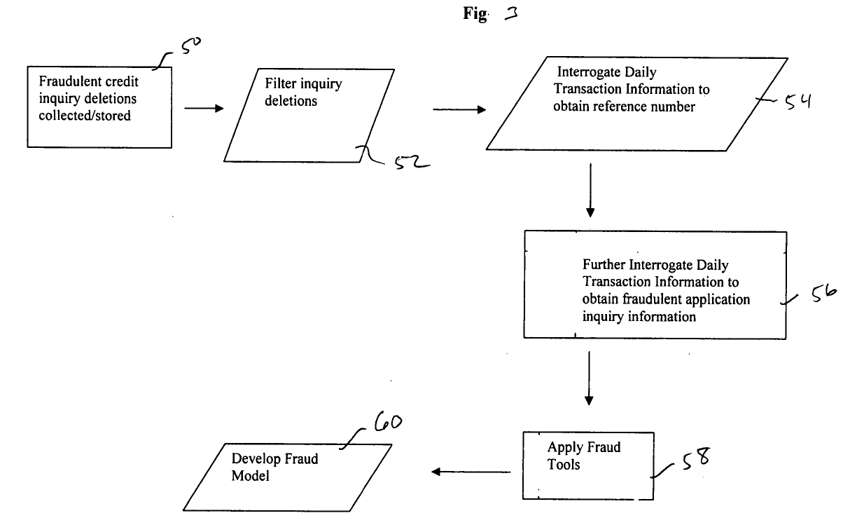

Referring to FIG. 2, a block diagram illustrates a system 26, comprising an element of the fraud management platform 10, for developing an analytic fraud model to predict likelihood that a transaction is fraudulent. The illustrated system 26 comprises a mainframe 28 including a display 30 and keyboard 32 for a user interface. A first, or log database 34 is operatively associated with the mainframe 28 for storing a log of transaction information comprising requests for credit reports and including application information used by a credit requestor. A second or fraud database 36 is operatively associated with the mainframe 28 for storing deleted credit inquiries. The deleted credit inquiries comprise fraudulent requests for credit reports. The mainframe 28 is connected via a network 38 to a fraud tools block 40 and a fraud model block 42. The fraud tools block 40 processes fraudulent and non-fraudulent credit transaction information to determine characteristics of such information. The fraud model block 42 comprises a processing system that builds a fraud model. In the illustrated embodiment of the invention, the fraud model 42 may use neural network software, or some other type of software, to develop the model. A neural network is a complex computer algorithm that creates estimates of future performance based on past behavior. Results are empirically derived and statistically sound. All analysis elements are input into the software along with the output of the fraud tools block 40. The software analyzes the relationships between all the possible elements to determine elements that are most predictive of fraud or non-fraud transactions. The process to determine which elements are predictive is hidden, meaning that it is not known how the software identifies the elements.

The system illustrated in FIG. 2 is one example of how a system can be configured. As will be apparent, all of the functionality could be implemented in a single processing system or could be developed using distributed processing techniques, as necessary or desired.

The present invention is not directed to any particular configuration of fraud model. Instead, the invention is directed to capturing a fraud model development sample used for developing the predictive fraud model.

In an exemplary embodiment of the invention, the system 26 uses application information supplied by credit requesters as part of credit transactions from thousands of fraudulent transactions and hundreds of thousands of non-fraudulent transactions over a select recent time period. The transactions can be captured from numerous industries, such as, for example, banks, department stores, travel and entertainment industries, finance companies, utilities, auto finance, credit unions and insurance companies. The sample advantageously is taken nationwide so that it is patterned indicative to fraud. For example, more records from a state such as California may be contained in the sample because they have a higher instance of fraud than a smaller state, such as Montana.

As generally discussed above, when a consumer applies for an extension of credit, a request for a credit report is made including application information used by the credit requester. The log database 34, see FIG. 2, stores a log of credit transaction information comprising these requests. The application information used by a credit requestor may include, for example, applicant's name, address, birth date, phone number and social security number. Each request for credit is identified with a reference indicator.

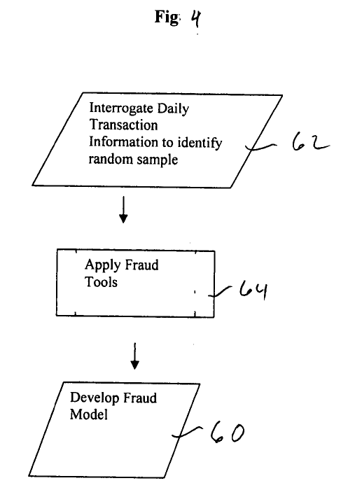

Referring to FIG. 3, a flow diagram illustrates the processing for determining characteristics of fraudulent application information used by credit requester. Beginning at a block 50, deleted credit inquiries are stored in a master file of data, such as the fraud database 36, see FIG. 2. These credit inquiries have been deleted from the consumer file because they were made by an individual misrepresenting themselves as someone they are not. The victim may have contacted the appropriate entity to remove these credit inquiries from consumer credit reports. Alternatively, a credit grantor may notify the appropriate entity. As such, the system 26 verifies that a credit request is fraudulent prior to deleting the fraudulent credit request.

A block 52 filters the stored deleted credit inquiries for a select period to obtain a sample of fraudulent transactions. The select period is generally within a specified time period to be determined at the time of sample collection. For example, the database 36 may be filtered for fraudulent inquiries made within the last six months. A block 54 interrogates daily transaction information to obtain a reference number. Particularly, the resulting file of deleted credit inquiries is cross-referenced with daily transaction information from the log database 34 using specific identifiers to obtain a reference number or indicator. The identifiers may be, for example, date, social security number and/or last name. As discussed above, the daily transaction information is a result of credit grantors requesting credit reports for credit extension purposes. A block 56 further interrogates daily transaction information to obtain fraudulent application inquiry information. Particularly, the reference number pinpoints the application information used by the fraudulent credit requestor to obtain credit. The application information collected for each such credit requestor may include applicant's name, address, birth date, phone number and social security number or other indicative personal information. A block 58 applies fraud tools to the resulting fraudulent application information to determine characteristics of fraudulent application information. This is done using generally available fraud tools. Such fraud tools may include verification analysis involving comparison of application elements to the elements contained on file for the individual to highlight inconsistencies. Application analysis involves comparison of application elements to elements contained on file and other public databases using sophisticated algorithms to highlight inconsistencies. High risk fraud alerts involve comparisons of the application address and the addresses residing on the file to determine if the address supplied at the time of the application is of high risk for being fraudulent. As is apparent, other types of fraud tools could be used. The present invention is not directed to any specific fraud tools, but rather the use of fraud tools as part of the process of developing a model.

A block 60 develops the fraud model. The resulting output from the fraud tools applied at the block 58 is used to develop a predictive fraud model.

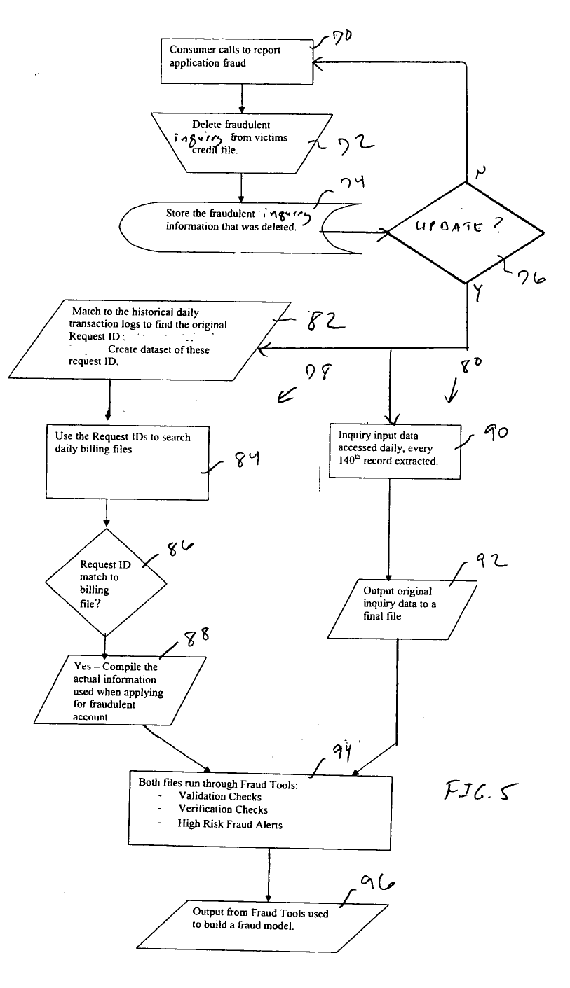

With reference to FIG. 4, the system and method according to the invention also uses a random sample of credit application information for non-fraudulent transactions. To obtain the non-fraudulent application information, a block 62 interrogates daily transaction information. Daily application information from the log database 34 is accessed, during the same time period as the fraudulent transactions, such as six months, which contains every application for credit that occurred on a given day during the relevant time period. To ensure a random sample, every Xth record containing application information is extracted. X is a positive integer. In an exemplary embodiment of the invention, every 140^{th} record is extracted. As will be apparent, a different sampling frequency can be used. The application information collected for each non-fraudulent applicant may be selected from applicant's name, address, birth date, phone number and social security number. A block 64 applies fraud tools to the good application information. The fraud tools are applied in the same manner as discussed above relative to the block 58. In fact, the processing of the blocks 58 and 64 could occur simultaneously or separately to determine characteristics of fraudulent and non-fraudulent application information used to make credit requests. The output from the fraud tools is then used in the fraud model development at the block 60, discussed above relative to FIG. 3.

Referring to FIG. 5, a flow diagram illustrates overall operation of the system and method for developing an analytic fraud model in accordance with the invention. The process begins at a block 70 when a consumer calls to report application fraud. The call might initially be directed to the entity issuing the credit when the consumer discovers they are a victim of application fraud such as someone using their information to open an account. The fraudulent account is deleted from the victim's credit file at a block 72, as discussed above. The fraudulent inquiry information that was deleted is stored, in the fraud database 36, see FIG. 2, at a block 74. Thereafter, a decision block 76 determines whether or not the model needs to be updated. If not, the process loops back to the block 70. This process repeats on an ongoing basis as fraud is reported by consumers, until such time as a fraud model is to be updated. The fraud model might be updated at a select frequency, such as every six months, or by customer request.

When it is necessary to update the fraud model, then the process proceeds along two paths. The first path 78 is to obtain characteristics of fraudulent application information. The second path 80 is to determine characteristics of non-fraudulent application information. The fraudulent path 78 begins at a block 82 which matches the historical daily transaction logs to find the original request Ids for fraudulent transactions. A data set of these request Ids is created. A block 84 uses the request Ids to search the daily transaction files which store the indicative transaction information for every request for a credit report. A decision block 86 determines if there is a match to a billing file for each request Id. For those that are, a block 88 compiles the actual information used when applying for the fraudulent account. This can include name, address, date of birth and social security number, for example, as discussed above.

The non-fraudulent application path 80 begins at a block 90 which extracts inquiry input data accessed daily for every 140^{th} record. The original inquiry data is output to a final file at a block 92. The information from the blocks 88 and 92 are then run through fraud tools at a block 94. As discussed above, these can include validation checks verification checks, and high risk fraud alerts. The output from the fraud tools is used to build a fraud model at a block 96. The process then ends for this update.

As will be apparent, the updating and storage of deleted credit requests is ongoing as part of the normal daily routine, notwithstanding actual updating of the fraud model.

The present invention has been described with respect to flowcharts and block diagrams. It will be understood that each block of the flowchart and block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

Thus, in accordance with the invention, there is provided an improved data gathering process for developing an analytic fraud model.

We claim:

1. The method of building a model to predict likelihood that a transaction is fraudulent, comprising:
storing a log of credit transaction information comprising requests for credit reports and including application information used by a credit requester;
storing deleted credit inquires, said deleted credit inquiries comprising fraudulent requests for credit reports;
filtering the stored deleted credit inquiries for a select period to obtain a sample of fraudulent transactions;
obtaining select fraudulent credit transaction information from the log for the sample of fraudulent transactions;
obtaining a sample of random credit transaction information for the select period from the log;
processing the fraudulent credit transaction information and the random credit transaction information to determine characteristics of fraudulent and non-fraudulent application information used by credit requesters; and
developing a predictive fraud model using the determined characteristics.

2. The method of building a model to predict likelihood that a transaction is fraudulent of claim 1 wherein the application information used by a credit requester is selected from applicant's name, address, birth date, phone number and social security number.

3. The method of building a model to predict likelihood that a transaction is fraudulent of claim 1 further comprising attempting to verify that a credit request is fraudulent prior to deleting the fraudulent credit requests.

4. The method of building a model to predict likelihood that a transaction is fraudulent of claim 1 wherein filtering the stored deleted credit inquiries comprises obtaining only most recent deleted credit inquiries.

5. The method of building a model to predict likelihood that a transaction is fraudulent of claim 1 wherein each request for credit is identified with a reference indicator and obtaining select fraudulent credit transaction information comprises cross referencing the deleted credit inquiries with the log to obtain the reference indicators for the deleted credit inquiries and the reference indicators are used to obtain the application information used by fraudulent credit requesters.

6. The method of building a model to predict likelihood that a transaction is fraudulent of claim 1 wherein obtaining a sample of random credit transaction information comprises obtaining application information for every Xth record in the log for the select period, wherein X is a positive integer.

7. The method of building a model to predict likelihood that a transaction is fraudulent of claim 1 wherein filtering the stored deleted credit inquiries comprises obtaining all of the deleted credit inquiries for the select period.

8. The method of building a model to predict likelihood that a transaction is fraudulent of claim 1 wherein the select period comprises a select number of months.

9. The method of developing an analytic fraud model, comprising:
storing a transaction log of application information used to make credit requests;
deleting credit inquiries from credit files that are determined to be fraudulent;
storing the deleted credit inquires;
obtaining select fraudulent application information from the transaction log for the stored deleted credit inquiries for a select recent time period;
obtaining a sample of random application information from the transaction log for the select recent time period;
processing the fraudulent application information and the random application information to determine characteristics of fraudulent and non-fraudulent application information used to make credit requests; and
developing a predictive fraud model using the determined characteristics.

10. The method of developing an analytic fraud model of claim 9 wherein the application information used to make a credit request is selected from applicant's name, address, birth date, phone number and social security number.

11. The method of developing an analytic fraud model of claim 9 wherein each credit request is identified with a reference indicator and obtaining select fraudulent application information comprises cross referencing the deleted credit inquiries with the transaction log to obtain the reference indicators for the deleted credit inquiries and the reference indicators are used to obtain the application information used by fraudulent credit requesters.

12. The method of developing an analytic fraud model of claim 9 wherein obtaining a sample of random application information comprises obtaining application information for every Xth record in the log for the select recent time period, wherein X is a positive integer.

13. The method of developing an analytic fraud model of claim 9 wherein obtaining select fraudulent application information comprises obtaining all of the deleted credit inquiries for the select recent time period.

14. A system for developing an analytic fraud model to predict likelihood that a transaction is fraudulent, comprising:
a first database storing a log of credit transaction information comprising requests for credit reports and including application information used by a credit requester;
a second database storing deleted credit inquires, said deleted credit inquiries comprising fraudulent requests for credit reports;
a programmed processing system operatively associated with the first and second databases operating in accordance with a sampling program to filter the stored deleted credit inquiries for a select period to obtain a sample of fraudulent transactions, obtain select fraudulent credit transaction information from the log for the sample of fraudulent transactions, obtain a sample of random credit transaction information for the select period from the log, and process the fraudulent credit transaction information and the random credit transaction information to determine characteristics of fraudulent and non-fraudulent application information used by credit requesters; and
means operatively associated with the programmed processing system for developing a predictive fraud model using the determined characteristics.

15. The system for developing an analytic fraud model of claim 14 wherein the application information stored in the first database used to make a credit report request is selected from applicant's name, address, birth date, phone number and social security number.

16. The system for developing an analytic fraud model of claim 14 wherein each request for a credit report is identified with a reference indicator and the sampling program obtains select fraudulent application information by cross referencing the deleted credit inquiries with the log of credit transaction information to obtain the reference indicators for the deleted credit inquiries and the reference indicators are used to obtain the application information used by fraudulent credit requesters.

17. The system for developing an analytic fraud model of claim 14 wherein the sampling program obtains a sample of random credit transaction information by obtaining application information for every Xth record in the log of credit transaction information for the select period, wherein X is a positive integer.

18. The system for developing an analytic fraud model of claim 14 wherein the sampling program obtains select fraudulent credit transaction information by obtaining all of the deleted credit inquiries for the select period.

19. The system for developing an analytic fraud model of claim 14 further comprising means for attempting to verify that a credit report request is fraudulent prior to storing the deleted credit inquiries in the second database.

20. The system for developing an analytic fraud model of claim 14 wherein the sampling program filters the stored deleted credit inquiries by obtaining only most recent deleted credit inquiries.
